(19) United States
(12) Patent Application Publication
(10) Pub. No.: US 2007/0085900 A1
(43) Pub. Date: Apr. 19, 2007

(54) Arrangement for transmitting video data to a mobile terminal traveling along a planned route

(75) Inventors: Gilles Dautun, Chennevieres Sur Marne (FR); Vincent Billault, St Fargeau Ponthierry (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/580,903

(22) Filed: Oct. 16, 2006

(30) Foreign Application Priority Data
Oct. 17, 2005 (FR) 0553137

(51) Int. Cl. H04N 7/14

(52) U.S. Cl. 348/14.01; 455/556.1

(57) ABSTRACT

A management arrangement for transmitting video data from a content delivery server to a mobile communications terminal. The arrangement of the invention is characterized in that it has: a database of possible routes and of possible timetables; a portal for determining a route and a timetable from among the possible routes and timetables, as a function of information supplied by the terminal, and concerning the planned journey of the terminal; means for determining a set of base stations situated along the route determined in this way; and means for transmitting a piece of said data to each of said base stations, each piece being determined as a function of the timetable determined by the portal.

The present invention relates to transmitting data from a Content Delivery Server (CDS) to a mobile communications terminal. It is particularly applicable to a situation in which the mobile communications terminal is moving along a predictable route, e.g. when it is on board a train, a bus, a subway train, or any other means of transport following a route and a timetable that are pre-set.

The data transmitted can, for example, be video data. One application of the invention then consists in viewing a video film or a television program in real time on a mobile communications terminal, the film or program being broadcast from a content delivery server.

In addition to video, the invention can also apply to transmitting audio data (music, radio documentaries, etc.), or other data (a map related to the location of the mobile terminal, for example).

It is well known that data can be transmitted from a content delivery server to a mobile communications terminal, through an infrastructure of communications networks including a set of base stations.

At any given time, the mobile terminal is connected to a base station, through which it receives the data transmitted by the content delivery server. As it travels, it comes to leave the vicinity of said base station and to enter the vicinity of another base station. In this well-known situation known as “handover”, the mobile communications terminal disconnects from the first base station and connects to the second base station.

But a major problem is then to prevent the user of the communications terminal from being aware of the handover. It is thus necessary to anticipate the handover so that, when the mobile terminal connects to the second base station, said second base station already has the data transmitted by the content delivery server, ready for onward transmission.

Such anticipation makes it possible, in principle, to solve the problem of making handover transparent for the user, and of procuring continuity in the quality of service, but it raises other problems that are so far unsolved in the state of the art.

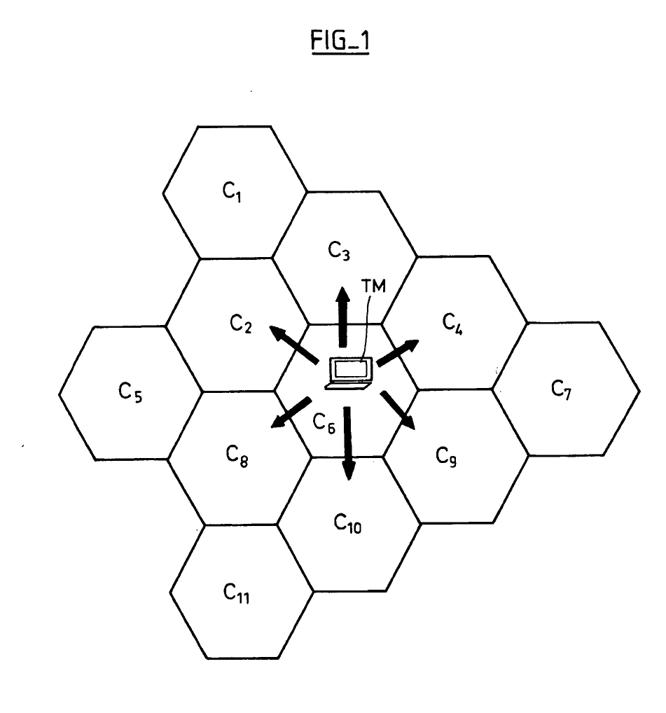

FIG. 1 diagrammatically shows a typical example of a radio-communications network of the cellular type. A geographic zone is made up of a set of “cells” C₁, C₂ . . . C₁₁ each of which corresponds to the coverage field of a single base station (the base stations not being shown). Each mobile terminal located in such a cell is thus connected to the associated base station, and the boundaries between the cells correspond to the handover zones.

In the example shown in FIG. 1, a mobile communications terminal MT is situated in cell C₆. Via the base station associated with the cell C₆, it receives data transmitted by a content delivery server (not shown). As it travels, it can enter one of the cells C₂, C₃, C₄, C₈, C₉, C₁₀. Therefore, in order to guarantee continuity in the quality of service, the data transmitted by the content delivery server must also be transmitted to the base stations of the neighboring cells C₂, C₃, C₄, C₈, C₉, C₁₀ that are adjacent to the cellule C₆.

Such a mechanism gives rise to two main families of technical problem: firstly, such transmissions of large volumes of data clog up the communications network, and all of the network elements between the content delivery server and the various base stations. Secondly, the data transmitted takes up a large amount of the volume of the buffer memory of each of the base stations involved.

Therefore, in order to guarantee quality of service, the operator of the communications network needs to over-dimension both the buffer memories of the base stations and also the transmission capacities of its communications network. Naturally, such an approach is costly and it should thus be avoided.

Partial solutions have been proposed, such as, for example, those disclosed in Patent Application EP 1 549 096, filed by Alcatel on Jun. 29, 2005 or in the article entitled “Management of cacheable streaming multimedia content in networks with mobile nodes” by Muhammad Mukarram Bin Tariq and Atsushi Takeshita, published in Globecom'02, IEEE Global Telecommunications Conference, Conference Proceedings, Taipei, Taiwan, 17-21 Nov. 2002. Those solutions make it possible to distribute multimedia contents in a mobile communications network while taking account of the location of the terminal and of the buffer memories of the base stations. However, management of the buffer memories is not optimized due to the need to use the location of the terminal.

An object of the invention is thus to reduce the needs of data transmission in the communications network, while also guaranteeing quality of service. To this end, the invention firstly provides a management arrangement for transmitting data, in particular video data, from a content delivery server to a mobile communications terminal via base stations provided with buffer memories and to which said mobile communications terminal is temporarily connected. Said arrangement also has:
a database of possible routes, storing the routes that the user of said terminal might take;
means for determining a set of base stations situated along one of said routes; and
means for transmitting a piece of said data to each of said base stations.

Said management arrangement is novel in that
the database associates possible timetables with the route;
it also has a portal for determining a route and a timetable from among the possible routes and timetables contained in the database, as a function of information supplied by the user of said communications terminal, and concerning the user's planned journey; and
each piece of data to be transmitted to the base stations is determined as a function of the timetable determined by the portal.

In an embodiment of the invention, the portal has a man-machine interface for proposing a set of possible routes and of possible timetables extracted from said database as a function of the location of said mobile terminal and of the current time, from which set the user of said terminal can choose a route and a timetable.

In order to mitigate a situation in which the timetable is not fully complied with, the arrangement of the invention for transmitting data also has monitoring means for determining the real checkpoint-passing times at which said mobile terminal goes past the base stations situated along said route, so as to compare them with said timetable and so as to adapt the transmission of the pieces of said data as a function of said comparison.

In a particular embodiment, said monitoring means determine the real checkpoint-passing times as a function of the signals received from the base stations.

In an embodiment, the time at which each of said pieces is transmitted to the corresponding base station is determined as a function of said timetable.

In an embodiment of the invention, each of said pieces includes a buffer quantity, in order to enable redundancy to be obtained around each subdivision of the data.

The buffer quantity may, for example correspond to a fixed length of time or to a variable length of time depending on the length of time of said piece.

The invention also provides a method of transmitting data, in particular video data, from a content delivery server to a mobile communications terminal via base stations provided with buffer memories and to which said mobile communications terminal is temporarily connected. The method includes the following steps:
a route and a timetable are determined from a database of possible routes and of possible timetables, as a function of information supplied by the communications terminal and concerning the planned journey of said terminal;
a set of base stations situated along the route is determined; and
a piece of said data is transmitted to each of the base stations, each piece being determined as a function of the timetable.

The invention and its advantages will appear more clearly from the following description of embodiments given with reference to the accompanying figures, in which:

FIG. 1, described above, shows a cellular communications network that is known from the state of the art;

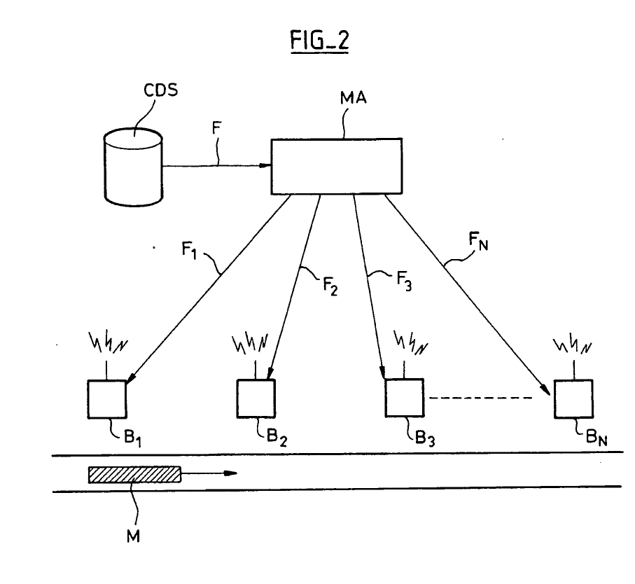

FIG. 2 shows an implementation of the invention;

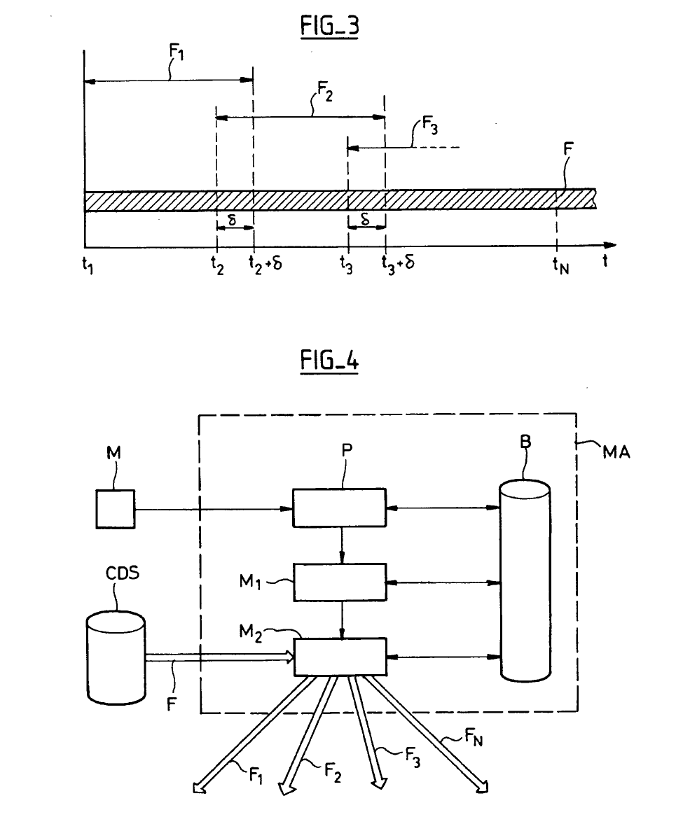

FIG. 3 is a timing diagram explaining the way in which the data is subdivided with a view to transmitting it, in an implementation of the invention; and

FIG. 4 is a diagram showing how the management arrangement of the invention operates.

Naturally, the mobile communications terminal of the invention can be a mobile phone, e.g. complying with standards such as the Global System for Mobile Communications (GSM), the Universal Mobile Telecommunications System (UMTS), etc. but it can also be a Personal Digital Assistant (PDA), a laptop microcomputer provided with radio interfaces, etc. It can also be a terminal that is not genuinely mobile, but rather that is secured to a vehicle that it is itself mobile, e.g. a viewing terminal incorporated in front of train or bus passengers.

In a manner known per se, the user of such a mobile terminal (or the like) can connect to a portal in order to select data to be viewed. Typically, it can be a film, a sports report, or a television program, or indeed music, a map, etc.

In the context of the invention, the user of the mobile terminal also connects to a portal that can be the same as or different from the above-mentioned portal in order to provide information concerning the user's planned journey. The planned journey can relate in particular to a route (space aspect) and to a timetable (time aspect).

The route corresponds to the route that the user is planning to take. It is thus a succession of checkpoints. Each of the checkpoints corresponds to a checkpoint-passing time. The entire set of checkpoint-passing times forms the timetable.

The user of the mobile terminal must thus provide a “route/timetable” pair. The user can do this merely by giving a route identifier (train number, bus number, destination, etc.) and a timetable identifier (departure time and/or arrival time). In which case, the more detailed information can be found in a database of possible routes and of possible timetables.

Preferably, the portal can propose a set of possible routes and timetables on the basis of the location of the mobile terminal and of the current time, as well as of information stored in a database of possible routes and of possible timetables.

This location can be determined by means known per se and accessible to the person skilled in the art. For example, it can merely be a question of determining to which base station the mobile terminal is connected. As a function of the position of the base station, and on the basis of a database containing all of the possible routes, the portal can determine which routes are accessible to the user of the mobile terminal.

For example, if the portal determines that the mobile terminal is located in a rail station, it can determine the entire set of routes and timetables corresponding to trains leaving said station as from the current time.

This set of routes and of timetables can be proposed on the screen of the mobile terminal in order to enable the user to choose the relevant route/timetable pair.

In the example shown in FIG. 2, the route chosen by the user is the route R, and the mobile terminal M moves along the route R in the direction indicated by the arrow.

After the user has selected the data that he or she wishes to receive via a portal (not shown), the user of the mobile terminal M uses the data transmission management arrangement MA to determine the route R and the timetable that he or she is planning.

As a function of the indications, the management arrangement MA has means for determining a set B₁, B₂, B₃ . . . B_{N} of base stations situated along the route R.

For this purpose, in the database of possible routes and of possible timetables that is available to the management arrangement MA, an association is made between each possible route and a corresponding set of base stations situated along the route R. Said association can be made by the operator of the communications network and can be installed in the database.

The data F chosen by the user is then transmitted by a Content Delivery Server (CDS) to the management arrangement MA in the form of a stream of information.

The management arrangement MA then subdivides the data into pieces to be transmitted to the set of base stations B₁, B₂, B₃ . . . B_{N}. These pieces are computed as a function of the determined timetable, i.e. of the time of passing near to each of the base stations.

FIG. 3 diagrammatically shows the way in which the data is subdivided into pieces. The data is shown horizontally as a stream of information F along the time axis T. The times t₁, t₂, t₃ . . . t_{N} of passing in the vicinity of respective ones of the base stations B₁, B₂, B₃ . . . B_{N} are plotted along the time axis.

The data F is then subdivided into respective pieces of data F₁, F₂, F₃ . . . F_{N-1} as a function of the checkpoint-passing times. Each piece Fₓ is determined as being the set of data that starts at time tₓ and that ends at tₓ₊₁.

In a preferred variant, a “buffer” quantity is provided in order to enable redundancy to be achieved around each subdivision of the data F, and thereby to avoid edge effects and to mitigate any small delays in the mobile terminal connecting to the base station B_{X+1}.

This buffer quantity corresponds to a length of time δ. In this variant, the piece of data to be transmitted to the base station Bₓ lies within the times Tₓ and Tₓ+δ. Redundancy is thus obtained about each redundancy corresponding to a length of time δ.

In other words, the same buffer quantity is transmitted both with a piece F_{X} and with the next piece F_{X+1}, it being understood that there is naturally no buffer quantity to be transmitted with the last component piece of the data to be transmitted.

It should be noted that said length of time δ is not necessarily identical for all of the pieces. Thus, rather than implementing a fixed length of time, it is possible to implement a variable length of time δ_{X} which, for example, depends on the volume of the piece. Thus, the length of time can be a fixed proportion of said piece, using a relationship δ_{X}=p×(t_{X+1}−t_{X}) in which p is a percentage.

The different pieces F₁, F₂, F₃ . . . F_{N} determined in this way are then transmitted to the corresponding base stations B₁, B₂, B₃ . . . B_{N}. They can then be transmitted all at the same time, or indeed the transmission can be distributed over time as a function of the timetable, and more particularly as a function of the planned times of passing nearby the base stations. Thus, it can be advantageous to reduce the time elapsed between transmission of a piece of data to a base station and transmission of said piece by the base station to the mobile terminal. It is thus a question of minimizing the difference between these two transmissions, optionally while taking account of the length of time of the transmission, and of the technological capacities of the base station (e.g. whether said base station is capable of starting to transmit the stream to the mobile terminal M before it has finished receiving said stream from the management arrangement MA).

This variant implementation thus makes it possible to improve the compactness of the buffer memories of the base stations, both in terms of volume occupied and in terms of time of occupancy.

In an embodiment of the invention, the management arrangement also has monitoring means. Said monitoring means determine the times at which the mobile terminal M goes past the base stations B₁, B₂, B₃ . . . B_{N}, compares these checkpoint-passing times with the timetable, and, where appropriate, adapts the transmissions of the pieces F₁, F₂, F₃ . . . F_{N} of the data as a function of said comparison.

Thus, when the mobile terminal M passes in the vicinity of a base station, said mobile terminal connects to said base station which transmits to it the corresponding piece of data. Said base station can then feed back a signal to the monitoring means of the management arrangement MA in order to inform it that the mobile terminal M has passed in its vicinity. By collecting these signals, the monitoring means can determine the real route and the various real checkpoint-passing times, and thus whether the mobile is late, on time, or early relative to the planned timetable, i.e. the timetable determined with the portal by the user. The monitoring means can thus make it possible for the management arrangement MA to adapt to the reality of the situation. It can thus re-compute the pieces of data remaining to be transmitted and can also modify the time at which it transmits them to the base stations.

FIG. 4 is a diagram showing how the management arrangement MA operates. Said arrangement includes a database B of the possible routes and of the possible timetables, the object of which is to store in an organized form all of the possible routes (train lines, bus routes, main roads, etc.), and to associate therewith the possible timetables (train timetables, bus timetables, etc, markers along a main road, etc.), as well as a set of base stations. The management arrangement MA also includes a portal P which makes it possible to determine a route and a timetable from among the content of the database B as a function of information supplied by the communications terminal M concerning the planned journey.

The determined route is transmitted to the means M₁ for determining a set of base stations situated along said route, on the basis of the content of the database B.

Finally, means M₂ are organized to transmit a piece of data F received from a content delivery server CDS to each of said base stations, each piece (F₁, F₂, F₃ . . . F_{N}) being determined as a function of the timetable determined by the portal P in collaboration with the database B.

1. A management arrangement (MA) for transmitting data (F), in particular video data, from a content delivery server (CDS) to a mobile communications terminal (M) via base stations provided with buffer memories and to which said mobile communications terminal is temporarily connected, said management arrangement being characterized in that it has:
a database of possible routes, storing the routes that the user of said terminal might take;
means for determining a set of base stations (B₁, B₂, B₃ . . . B_{N}) situated along one of said routes; and
means for transmitting a piece of said data to each of said base stations;
said management arrangement being characterized in that said database associates possible timetables with said routes, and in that it also has a portal for determining a route (R) and a timetable from among said possible routes and timetables, as a function of information supplied by the user of said communications terminal, and concerning the user's planned journey, and in that each piece (F₁, F₂, F₃ . . . F_{N}) is determined as a function of said timetable.

2. A management arrangement (MA) for transmitting data (F) according to claim 1, in which said portal has a man-machine interface for proposing a set of possible routes and of possible timetables extracted from said database as a function of the location of said mobile terminal and of the current time, from which set the user of said terminal can choose a route and a timetable.

3. A management arrangement (MA) for transmitting data (F) according to claim 1, also having monitoring means for determining the real checkpoint-passing times at which said mobile terminal (M) goes past the base stations (B₁, B₂, B₃ . . . B_{N}) situated along said route (R), so as to compare them with said timetable and so as to adapt the transmission of the pieces (F₁, F₂, F₃ . . . F_{N}) of said data as a function of said comparison.

4. A management arrangement (MA) for transmitting data (F) according to claim 3, in which said monitoring means determine the real checkpoint-passing times as a function of the signals received from said base stations (B₁, B₂, B₃ . . . B_{N}).

5. A management arrangement (MA) for transmitting data (F) according to claim 1, in which the time at which each of said pieces (F₁, F₂, F₃ . . . F_{N}) is transmitted to the corresponding base station is determined as a function of said timetable.

6. A management arrangement (MA) for transmitting data (F) according to claim 1, in which each of said pieces includes a buffer quantity, in order to enable redundancy to be obtained around each subdivision of said data (F).

7. A management arrangement (MA) for transmitting data (F) according to claim 1, in which the buffer quantity corresponds to a fixed length of time.

8. A management arrangement (MA) for transmitting data (F) according to claim 6, in which the buffer quantity of each of said pieces corresponds to a variable length of time depending on the length of time of said piece.

9. A method of transmitting data (F), in particular video data, from a content delivery server (CDS) to a mobile communications terminal (M) via base stations (B₁, B₂, B₃ . . . B_{N}) provided with buffer memories and to which said mobile communications terminal is temporarily connected, in which method:
a route (R) and a timetable are determined from a database of possible routes and of possible timetables storing the routes that the user of said terminal might take, as a function of information supplied by the user of said communications terminal and concerning the planned journey of said user;
a set of base stations (B₁, B₂, B₃ . . . B_{N}) situated along said route (R) is determined; and
a piece of said data is transmitted to each of said base stations.
said method being characterized in that said database associates possible timetables with said routes, and in that it also has a portal for determining a route (R) and a timetable from among said possible routes and timetables, as a function of information supplied by the user of said communications terminal, and concerning the user's planned journey, and in that each piece (F₁, F₂, F₃ . . . F_{N}) is determined as a function of said timetable.

10. A method according claim 9, in which the real checkpoint-passing times at which said mobile terminal (M) goes past the base stations (B₁, B₂, B₃ . . . B_{N}) situated along said route (R) are determined so as to compare them with said timetable and so as to adapt the transmission of the pieces (F₁, F₂, F₃ . . . F_{N}) of said data as a function of said comparison.

11. A method according to claim 9, in which the time at which each of said pieces (F₁, F₂, F₃ . . . F_{N}) is transmitted to the corresponding base station is determined as a function of said timetable.

12. A method according to claim 9, in which each of said pieces includes a buffer quantity, in order to enable redundancy to be obtained around each subdivision of said data (F).
